(19) United States
(12) Patent Application Publication
(10) Pub. No.: US 2007/0099576 A1
(43) Pub. Date: May 3, 2007

(54) Method and apparatus for base station management

(76) Inventors: Ivan N. Vukovic, Arlington Heights, IL (US); Eric H. Chan, Streamwood, IL (US); John M. Harris, Chicago, IL (US); Rangsan Leelahakriengkrai, Streamwood, IL (US); Lena Srey, Carpentersville, IL (US); Fan Wang, Vernon Hills, IL (US)

Correspondence Address: MOTOROLA, INC., 1303 EAST ALGONQUIN ROAD, IL01/3RD, SCHAUMBURG, IL, 60196, US

(21) Appl. No.: 11/266,526

(22) Filed: Nov. 3, 2005

(51) Int. Cl. H04B 17/00; H04Q 7/20; H04B 7/00

(52) U.S. Cl. 455/67.13; 455/502; 455/436

(57) ABSTRACT

An apparatus and method for determining (410) a quality of channel factor for a base transceiver station (530) of an active set and determining (420) whether the base transceiver station (530) should be assigned to a prefill set at least in part according to a predetermined function of the factor. The predetermined function may include assigning (425) a base transceiver station (530) to the prefill set when the quality of channel factor reaches a predetermined threshold. The quality of channel factor may be determined in various ways including executing (416) an anticipative signal strength algorithm or by monitoring (412) the quality of channel between the mobile station (110) and the base transceiver station (530). Additionally, the primary base transceiver station (120) may be notified (430) of the prefill set such that synchronization signals may be sent (440) to the base transceiver stations of the prefill set.

### TECHNICAL FIELD

This invention relates generally to wireless communication systems and more particularly to wireless communication systems that manage base stations to facilitate mobile station transfers between base stations.

### BACKGROUND

Many wireless communication systems are known in the art. In such systems, a mobile station, such as a phone, wirelessly networked computer, or other wireless communication device transmits data to and from a stationary transceiver. The stationary transceiver, commonly known as a base transceiver station, is connected to a network such that information may be shared with other systems. Because the mobile stations move relative to the base transceiver stations, eventually the wireless signal will weaken to the point that the mobile station will need to switch its wireless communication to another base transceiver station.

Wireless communication systems employ various known techniques to facilitate the transfer of a mobile station from one base transceiver station to another. Certain wireless communication systems will wait until the system determines that the mobile station needs to transfer base transceiver stations to begin a transfer of data. In such a system, the transfer cannot occur until the mobile station signals to the system that a transfer should occur. In a typical system, at that time, a controller will then forward the data to be sent to the mobile station to the target base station transceiver instead of the primary base station transceiver. Waiting for this data transfer results in a delay in the operation of the system for the mobile station user.

In certain high speed networks, a central server will forward the data to be sent to a mobile station to every base transceiver station in the active area of the mobile station at a given frequency or at certain times or intervals to reduce the delay experienced during a handoff. In other words, the system will send the data to not only the base transceiver station with which the mobile station is communicating, the primary base transceiver station, but also to every base transceiver station to which the mobile station may switch its communication surrounding that primary base transceiver station. This flooding technique results in larger data traffic volumes within the network as data is needlessly sent to multiple base transceiver stations. The larger data volumes, in turn, can overly tax the system's resources.

Further, when a mobile station experiences a handoff in such a high speed system, the target base transceiver station will send all the data previously received by the target base transceiver station for that mobile station. Often, the mobile station had previously received much of this data from the primary base transceiver station prior to the handoff. Sending synchronization signals to the base transceiver stations neighboring the primary base transceiver station to synchronize the data at the neighboring base transceiver stations with the data at the primary base transceiver station can reduce the redundancy in resending data to the mobile station during handoffs. Sending too many synchronization signals to too many base transceiver stations, however, can introduce further inefficiencies and burdens on the system.

### BRIEF DESCRIPTION OF THE DRAWINGS

The above needs are at least partially met through provision of the method and apparatus for base station management described in the following detailed description, particularly when studied in conjunction with the drawings, wherein:

FIG. 1 is a block diagram of a wireless communication system as configured in accordance with various embodiments of the invention;

FIG. 2 is a block diagram of a portion of the wireless communication system of FIG. 1 as configured in accordance with various embodiments of the invention;

FIG. 3 is a flow diagram depicting a method as configured in accordance with various embodiments of the invention;

FIG. 4 is a flow diagram depicting a method as configured in accordance with various embodiments of the invention;

FIG. 5 is a block diagram of a wireless communication system as configured in accordance with various embodiments of the invention; and

FIG. 6 is a flow diagram depicting a method as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, an apparatus and method for determining a quality of channel factor for a base transceiver station of an active set of base transceiver stations is provided such that it may be determined whether the base transceiver station should be assigned to a prefill set of base transceiver stations at least in part according to a predetermined function of the quality of channel factor. The active set of base transceiver station(s) is typically a set of one or more base transceiver stations in communication with a mobile station. The prefill set of base transceiver station(s) is a set of one or more base transceiver stations from the active set that appear most likely to receive a handoff from a primary base transceiver station. The identity and number of base transceiver stations in the active and prefill sets typically changes over time depending on various conditions such as, for example, the quality of channel between the base transceiver stations and a mobile station or the rate at which a mobile station travels relative to the base transceiver station locations. The prefill set of base transceiver stations will typically receive synchronization signals because these base transceiver stations are typically more likely to accept a handoff of a given mobile station from the primary base transceiver station.

Advantageously, this method and apparatus for managing base stations allows for adaptation of the set of base transceiver stations which receive synchronization signals to optimize the performance of the wireless communication system. For example, fewer system resources need be used by tailoring the number of base transceiver stations which receive synchronization data to the needs of the mobile station.

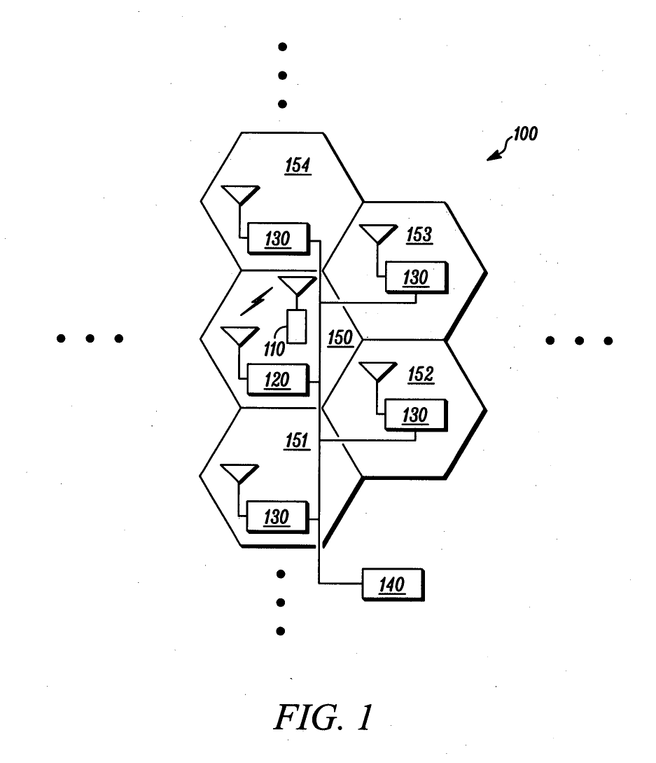

Referring now to the drawings, and in particular to FIG. 1, a wireless communication system 100 is provided including a mobile station 110 in wireless communication with a primary base transceiver station 120. The primary base transceiver station 120 is identical to or similar to the neighboring base transceiver stations 130 elsewhere in the wireless communication system 100. The base transceiver stations are networked or otherwise in communication with a base station controller 140. A wireless communication zone 150 is defined around the primary base transceiver station 120. Similarly, wireless communication zones 151, 152, 153, 154, 155, and 156 are defined around each base transceiver station 130. A mobile station in a zone will likely have as its primary base transceiver station the base transceiver station for that zone, and the mobile station will likely transfer its communications via a known handoff procedure to a new base transceiver station when the mobile station moves to a new zone within the wireless communication system 100.

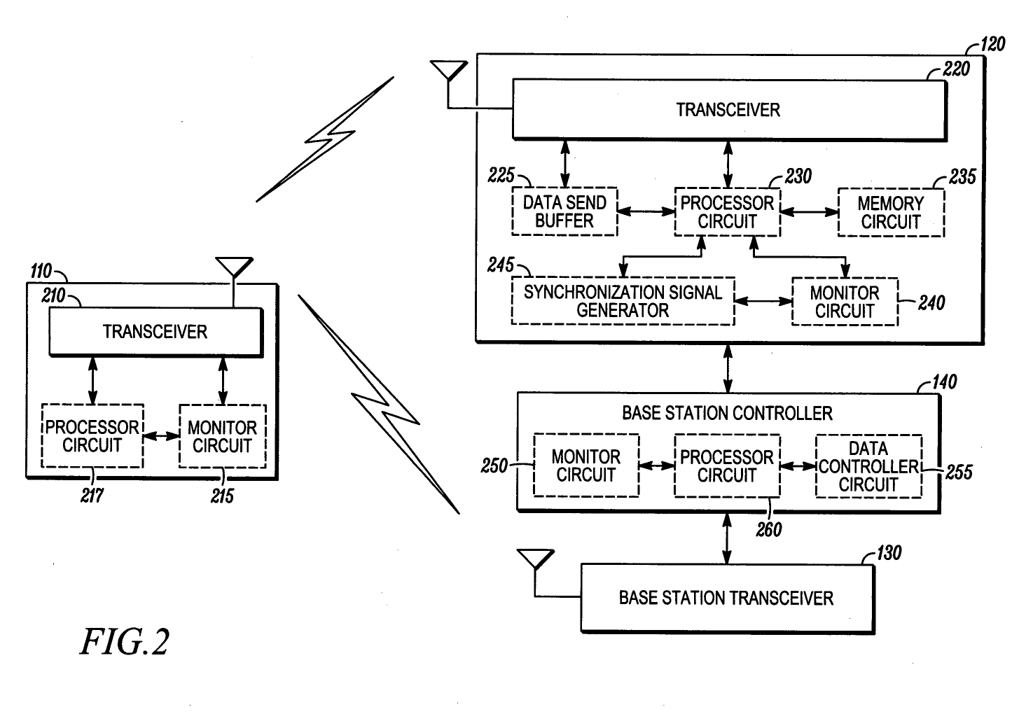

A typical embodiment of the invention will be described with reference to FIG. 2. The mobile station 110 is in wireless communication with the primary base transceiver station 120. The mobile station 110 includes a transceiver 210, a monitor circuit 215, and a processor circuit 217. The monitor circuit 215 typically includes one or more of the following: a peak hour time monitor, a quality of service factor monitor, a quality of channel factor monitor, a mobility factor monitor, a transmission rate monitor, and/or other appropriate monitor.

The primary base transceiver station 120 may include several components such as a transceiver 220 that is responsive at least in part to a data send buffer 225 and a processor circuit 230. The data send buffer 225 is also responsive to the processor circuit 230, and the processor circuit 230 is responsive to a memory circuit 235 and a monitor circuit 240. The monitor circuit 240 is capable of monitoring one or more factors relative to the wireless communication system 100. The monitor circuit 240 may comprise one or more of the following: a peak hour time monitor, a primary base transceiver station, a quality of channel factor monitor, a neighboring base transceiver station a quality of channel factor monitor, a quality of service factor monitor, a sent data monitor, a buffer monitor, a transmission rate monitor, and/or other appropriate factor monitor. A synchronization signal generator circuit 245 is responsive to the processor circuit 230 and the monitor circuit 240. Similarly, the neighboring base transceiver station 130 may include a monitor circuit (not shown).

A base station controller 140 is in communication with a plurality of base transceiver stations 120 and 130. Typically, the base station controller 140 is in communication with each base transceiver station 130 that neighbors the primary base transceiver station 120. The base station controller 140 also may include a monitor circuit 250, a data controller circuit 255, and a processor circuit 260. The monitor circuit 250 may comprise one or more of the following: a peak hour time monitor, a traffic load for a sector monitor, a quality of service factor monitor, a quality of channel factor monitor, a mobility factor monitor, a sent data monitor, a transmission rate monitor, and/or other appropriate factor monitor. The synchronization signal generator circuit 245 may be responsive to the monitor circuit 250 and/or the processor circuit 260.

One skilled in the art will recognize that the various individual circuits, monitors, and elements described herein, even when combined as described to form an embodiment of the invention, are readily designed by one skilled in the art and may operate in conjunction with various software elements to perform according to this description. For example, the various monitors are typically processor circuits operating in conjunction with certain software elements. Other enabling structure can be applied by those skilled in the art as desired as well.

It will be further understood that the various monitor circuits 215, 240, and/or 250 will output a signal corresponding to the factor being monitored. This signal will be communicated to the synchronization signal generator circuit 245, typically through the processor circuit 230, such that the synchronization signal generator circuit 245 may send synchronization signals in part in response to a function of the factors monitored by the monitor circuits 215, 240, and/or 250. For example, for a factor monitored by a first monitor circuit 215, a signal from this monitor circuit 215 will be sent wirelessly during the normal operation of the mobile station 110 to the primary base transceiver station 120 whereupon it will be received by the processor circuit 230. Similarly, for a factor monitored by a second monitor circuit 250, a signal from this second monitor circuit 250 will be transmitted during the normal operation of the base station controller 140 to the primary base transceiver station 120 whereupon it will be received by the processor circuit 230. The processor circuit 230 in coordination with the synchronization signal generator circuit 245 will then apply the predetermined function to the factor based on the received signal, and the synchronization signal generator circuit 245 will generate synchronization signals according to the function. One skilled in the art will recognize that the processor circuit 230 and the synchronization signal generator circuit 245 may be separate structures or contained within the same circuitry or structure.

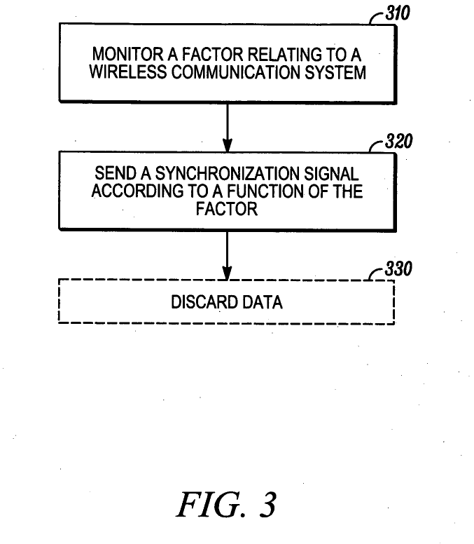

The operation of a typical embodiment for sending synchronization signals will be further described with reference to FIG. 3. The monitor circuit 215, 240, and/or 250 monitors 310 at least one factor relating to a wireless communication system 100. The synchronization signal generator circuit 245 sends 320 a synchronization signal to at least one base transceiver station 130 neighboring a primary base transceiver station 120 at least in part according to a predetermined function of the at least one factor. The synchronization signal may be any signal to the neighboring base transceiver stations 130 that facilitates synchronization with the primary base transceiver station 120 such that redundancy in data transmission is lessened during a handoff of a mobile station 110 from the primary base transceiver station 120 to a neighboring base transceiver station 130.

For example, the step of sending 320 the synchronization signal may include sending a signal corresponding to an indication of data at a front end of the data send buffer circuit 225 corresponding to the primary base transceiver station 120. In such an embodiment, the neighboring base transceiver stations 130 receive data to send to the mobile station 110 in case the mobile station 110 transitions to one of the neighboring base transceiver stations 130. The processor circuit 230 reads the data send buffer circuit 225 to determine the data portions at the front end of the buffer that are then most likely to be sent. The synchronization signal generator circuit 245 in conjunction with the processor circuit 230 generates the synchronization signal which is sent to and notifies the neighboring base transceiver stations 130 as to which data portion is close to being sent by the primary base transceiver station 120. In this manner, the neighboring base transceiver stations 130 may arrange the data stored at the neighboring base transceiver stations 130 to place the indicated data at the front end of the buffer.

In an alternative embodiment, the step of sending 320 the synchronization signal may include sending a signal corresponding to a mapping of data stored in a data send buffer circuit 225 corresponding to the primary base transceiver station 120. In this embodiment, the processor circuit 230 reads the data send buffer circuit 225 to map the data in the buffer. The synchronization signal generator circuit 245 in conjunction with the processor circuit 230 generates the synchronization signal which provides a data map of the data in the data send buffer circuit 225 such that the neighboring base transceiver stations 130 may arrange their data to be identical or substantially the same as the data in the primary base transceiver station 120.

In another embodiment, the step of sending 320 the synchronization signal may include the processor circuit's 230 determining at the primary base transceiver station 120 a transmission rate history for a mobile station 110, the processor circuit's 230 predicting in accordance with the transmission rate history a data set that will be at a front end of a data send buffer circuit 225 corresponding to the primary base transceiver station 120 when a neighboring base transceiver station 130 receives the synchronization signal, and the synchronization signal generator circuit's 245 sending a signal corresponding to the data set. In this embodiment, the processor circuit 230, in conjunction with a memory circuit 235, tracks the transmission history for data sent to the mobile station 110. By analyzing that transmission history stored in the memory circuit 235 using known algorithms, the processor circuit 230 can predict what data in the data send buffer circuit 225 will most likely be next to send to the mobile station 110 when a synchronization signal reaches a neighboring base transceiver station 130. Therefore, the synchronization signal generator circuit 245 in conjunction with the processor circuit 230 will send a signal to one or more neighboring base transceiver stations 130 that indicates to the stations what data is most likely to be sent next to the mobile station 110.

In yet another embodiment, the step of sending 320 the synchronization signal may include the processor circuit's 230 determining at the primary base transceiver station 120 a transmission rate history for a mobile station 110, the processor circuit's 230 predicting in accordance with the transmission rate history a certain data set that will be at a front end of a data send buffer circuit 225 corresponding to the primary base transceiver station 120 when a neighboring base transceiver station 130 receives the synchronization signal, and the synchronization signal generator circuit's 245 sending a signal corresponding to the certain data set. Similar to the other embodiments, the neighboring base transceiver stations 130 receive data to send data to the mobile station 110 in case the mobile station 110 transitions to one of the neighboring base transceiver stations 130. Then, in this embodiment, the processor circuit 230, in conjunction with a memory circuit 235, tracks the transmission history and/or call type for data sent to the mobile station 110. By analyzing that call type (e.g. a streaming service) or transmission history stored in the memory circuit 235 using known algorithms, the processor circuit 230 can predict the certain data set in the data send buffer circuit 225 that will be next sent to the mobile station 110 when a synchronization signal reaches a neighboring base transceiver station 130 or force that certain data set to be the next to be sent to the mobile station 110. Therefore, the synchronization signal generator circuit 245 in conjunction with the processor circuit 230 will send a signal to one or more neighboring base transceiver stations 130 that indicates to the stations the certain data set to be sent next to the mobile station 110 upon receipt of the synchronization signal or over the next time interval.

This embodiment can be applied to streaming services, for example, where the synchronization signal indicates to the neighboring base transceiver stations 130 that exactly one additional packet will be sent by the end of each 200 millisecond interval, starting at a given time. Additionally, the synchronization signal can indicate that each of those packets will not be sent earlier than 200 milliseconds before the time by which they are guaranteed to be delivered. In other words, in this example, the packet is guaranteed to be delivered sometime during a specific 200 millisecond interval. Thus, in this case, if a reselection or handoff occurs on one of these 200 millisecond boundaries, then the target base transceiver station can know exactly which data has been transmitted from the previous primary base transceiver station.

In yet another alternative embodiment, the step of sending 320 the synchronization signal may include the processor circuit's 230 determining at the primary base transceiver station 120 a transmission rate history for a mobile station 110 and the synchronization signal generator circuit's 245 sending a signal corresponding to the transmission rate history. Similar to the other embodiments, the neighboring base transceiver stations 130 receive data to send to the mobile station 110 in case the mobile station 110 transitions to one of the neighboring base transceiver stations 130. Then, in this embodiment, the processor circuit 230, in conjunction with a memory circuit 235, tracks the transmission history for data sent to the mobile station 110. The synchronization signal generator circuit 245 in conjunction with the processor circuit 230 will send a signal to the one or more neighboring base transceiver stations 130 that corresponds to the transmission history. By analyzing that transmission history using known algorithms, a processor circuit in the neighboring base transceiver stations 130 can determine according to the transmission rate history discardable data that need not be sent to the mobile station 110 because such data will be redundant. The neighboring base transceiver stations 130 then may discard 330 the discardable data. In this way, the neighboring base transceiver stations 130 may determine and set the data that will be the next sent to the mobile station 110 at a given time.

Similarly, under any of the above embodiments, the neighboring base transceiver stations 130 may discard 330 data in response to receiving the synchronization signal. In this way, the neighboring base transceiver stations 130 may discard 330 whatever data will not need to be sent to the mobile station 110 should the mobile station 110 transition into active communication with the neighboring base transceiver station 130. Therefore, redundant data is eliminated, lessening the volume of data transmitted in the system.

In another alternative, the step of sending 330 the synchronization signal is performed in conjunction with sending data other than the synchronization signal to a base station controller 140 from the primary base transceiver station 120. One skilled in the art will recognize that to send a synchronization signal from the primary base transceiver station 120 to one or more neighboring base transceiver stations 130, the primary base transceiver station 120 will typically send the synchronization signal to the base station controller 140 that in turn will direct the synchronization signal to the appropriate neighboring base transceiver station(s) 130. By piggy-backing the synchronization signal along with other data sent to the base station controller 140 during the normal operation of the primary base transceiver station 120, this embodiment will conserve the resources involved in sending multiple messages to the base station controller 140 from the primary base transceiver station 120.

Also, under any of the above embodiments, the step of sending 320 the synchronization signal may be performed in conjunction with sending updated data to the one or more neighboring base transceiver stations 130. This alternative streamlines the process of sending the synchronization signals by associating such signals with the data sent to the neighboring base transceiver stations 130 for the purpose of speeding up the handoff procedure. In one such embodiment, the synchronization signal is sent to the base station controller 140 which stores the synchronization signal until the data controller circuit 255 determines that data should be sent to one or more neighboring base transceiver stations 130. Thus, the synchronization signal may be sent with such data.

The sending of the synchronization signal may be controlled by a predetermined function of one or more factors of the wireless communication system. As noted above, any number of monitors 215, 240, and/or 250 at the mobile station 110, a base transceiver station 120 and/or 130, and/or at a base station controller 140 may monitor 310 any number of the factors. Depending on the factors monitored, the predetermined function determines when or how often synchronization signals are sent to the one or more neighboring base transceiver stations 130 that receive the signals.

In one alternative, the peak hour time monitor monitors whether the wireless communication system 100 is operating at a peak hour time. The peak hour time is a time during which the system 100 typically experiences the highest call and/or data traffic volumes, and the peak hour time can be previously determined based on the system's history or can be determined by the base station controller 140 or other structure on a periodic basis. The peak hour time monitor can be located at the base station controller 140, the primary base transceiver station 120, the mobile station 110, or other appropriate location. In operation, the peak hour time monitor typically monitors the peak hour time and is in communication with the processor circuit 230 and/or the synchronization signal generator circuit 245 such that the synchronization signal generator circuit 245 sends synchronization signals at a predetermined rate when the peak hour time monitor detects that the wireless communication system 100 is operating at the peak hour time. The predetermined rate will be at a rate less than the rate at which synchronization signals are sent when the wireless communication system 100 operates at a time outside of the peak hour time so that the synchronization signals do not place further strain on the system 100 when the system 100 experiences high traffic volumes.

In another embodiment, the traffic load monitor monitors the traffic load for at least a portion of the wireless communication system 100. The traffic load monitor can be located at the base station controller 140, the primary base transceiver station 120, or other appropriate location. In operation, the traffic load monitor, as typically located at the base station controller 140, monitors the traffic load for the group of base transceiver stations controlled by the base station controller 140. Alternatively, the traffic load monitor when located at the primary base transceiver station 120 monitors the traffic load for the primary base transceiver station 120. Based upon the monitored traffic load, the synchronization signal generator circuit 245 in communication with the traffic load monitor sends synchronization signals at a predetermined rate when detecting that the traffic load for a sector exceeds a predetermined level. The predetermined level is set according to the traffic capacity for the particular portion of the wireless communication system 100 monitored by the traffic load monitor. Therefore, the predetermined rate will be at a rate less than the rate at which synchronization signals are sent when the traffic load is below the predetermined level so that the synchronization signals do not further over burden the system 100 when experiencing high signal traffic volumes.

In yet another embodiment, a primary base transceiver station quality of channel factor monitor and a neighboring base transceiver station quality of channel factor monitor will monitor the signal strength or other appropriate factors relating to the quality of the communication channel between the primary base transceiver station 120 and the mobile station 110 and between a neighboring base transceiver station 130 and the mobile station 110. The primary base transceiver station quality of channel factor monitor is typically located at the primary base transceiver station 120, and the neighboring base transceiver station quality of channel factor monitor is typically located at a neighboring base transceiver station 130. Alternatively, the quality of channel factor monitor may be located at the mobile station 110 for monitoring each communication channel.

The quality of channel factor monitors typically detect the signal strength using any known circuitry and associated algorithms to detect the signal strength between a given mobile station 110 and a base transceiver station. The processor circuit 230 using known or readily developable algorithms monitors the relationship between the primary base transceiver station's 120 monitored quality of channel factor relative to the mobile station 110 and the neighboring base transceiver station's 130 monitored quality of channel factor relative to the mobile station 110. Based upon this relationship, the synchronization signal generator circuit 245 in communication with the processor circuit 230 sends synchronization signals at a predetermined rate when detecting that the quality of channel factor of the at least one base transceiver station 130 neighboring the primary base transceiver station 120 exceeds a predetermined level relative to the primary base transceiver station quality of channel factor. The predetermined level is typically based upon a signal strength ratio that indicates that the mobile station is likely to soon experience a handoff from the primary base transceiver station 120 to a neighboring base transceiver station 130. Therefore, the predetermined rate will be at an increased level when the neighboring base transceiver station signal strength exceeds a predetermined level relative to the primary base transceiver station signal strength to increase the efficiency of the handoff when the handoff to the neighboring base transceiver station 130 occurs. Alternatively, the synchronization signal generator circuit 245 in communication with the processor circuit 230 sends synchronization signals at a predetermined rate when detecting that the quality of channel factor of the primary base transceiver station 120 exceeds a predetermined level because at higher quality levels, the mobile station 110 is unlikely to experience a handoff.

In a similar embodiment, a quality of service factor monitor monitors a quality of service factor for the mobile station 110. Typically, the quality of service factor monitor detects one or more factors relative to the quality of service for the mobile station 110 relative to the primary base transceiver station 120 during data transmission such as bit error rate and so forth. Alternatively, the quality of service factor monitor may detect one or more quality of service factors for the mobile station 110 relative to one or more neighboring base transceiver stations 130. The quality of service factor monitor may be located in the mobile station 110 for any case, in the primary base transceiver station 120 to monitor the quality of service between the primary base transceiver station 120 and the mobile station 110, or in a neighboring base transceiver station 130 to monitor the quality of service between the neighboring base transceiver station 130 and the mobile station 110.

In communication with the quality of service factor monitor and/or the processor circuit 230, the synchronization signal generator circuit 245 sends synchronization signals at a predetermined rate when detecting that the quality of service factor exceeds a predetermined level. For example, the quality of service factor monitor measures the error rate between the mobile station 110 and the primary base transceiver station 120. When the error rate drops below a predetermined level indicating that the quality of service between the mobile station 110 and the primary base transceiver station 120 is better than the predetermined level, the synchronization signal generator circuit 245 will send synchronization signals at a lesser rate than when the error rate exceeds the predetermined level. In other words, the synchronization signals will be sent less often when the quality of service between the primary base transceiver station and the mobile station is high because it is unlikely that the mobile station will need a handoff when the quality of service is high. Such an embodiment is particularly useful when the mobile station 110 is receiving streaming data because the quality of service strongly affects the quality of the mobile station 110 user's experience.

In still another embodiment, a mobility factor monitor monitors a mobility factor for a given mobile station 110. Typically, the mobility factor monitor is located in a base station controller 140 or in the mobile station 110. The mobility factor monitor measures, for example, the rate at which the mobile station 110 is moving thereby necessitating handoffs between base transceiver stations. In communication with the mobility factor monitor and/or the processor circuit 230, the synchronization signal generator circuit 245 sends synchronization signals at a predetermined rate when detecting that the mobility factor exceeds a predetermined level. Typically, the predetermined rate is an increased rate when the mobility factor exceeds the predetermined level because a mobile station that has a high mobility will likely experience more handoffs. Therefore, sending more synchronization signals for that mobile station increases the efficiency when the handoffs do occur.

In another alternative embodiment, a sent data monitor monitors a data amount sent to a given mobile station 110 from the primary base transceiver station 120. The sent data monitor is typically located at the primary base transceiver station 120 but may also be located at the base station controller 140. In communication with the sent data monitor and/or the processor circuit 230, the synchronization signal generator circuit 245 sends synchronization signals at a predetermined rate when detecting that the data amount sent to the mobile station 110 from the primary base transceiver station 120 exceeds a predetermined level. In this way, synchronization signals typically are sent more often when the mobile station 110 receives higher volumes of data. This arrangement increases efficiencies by ensuring that a lesser volume of old data is sent to the mobile station 110 upon a handoff.

In another alternative, a buffer monitor monitors a buffer data size stored in a buffer corresponding to the primary base transceiver station 120. The buffer monitor is often at the primary base transceiver station 120 and in communication with a data send buffer 225. In communication with the buffer monitor and/or the processor circuit 230, the synchronization signal generator circuit 245 sends synchronization signals at a predetermined rate when detecting that the buffer data size stored in the data send buffer 225 exceeds a predetermined level. Typically then, synchronization signals are sent less often when the buffer data size exceeds certain levels because larger amounts of data are yet to be sent to the mobile station 110. Conversely, synchronization signals may be sent more often when the buffer data size decreases because less data will be sent. In this way, the synchronization signals are sent more often when there is less data to manage during a handoff of the mobile station 110 thereby increasing efficiency. In other words, the synchronization signals are sent more often when the rate of data being sent to the mobile station 110 is higher. This is advantageous because if data is sent to the mobile station 110 more rapidly, a larger discrepancy can arise between the data sent from the primary base transceiver station 120 and the synchronization data at the neighboring base transceiver station(s) 130.

In still another alternative, a transmission rate monitor monitors a transmission rate from the primary base transceiver station 120 to the mobile station 110. The transmission rate monitor is typically at the primary base transceiver station 120 and in communication with a data send buffer 225. In communication with the transmission rate monitor and/or the processor circuit 230, the synchronization signal generator circuit 245 sends synchronization signals at a predetermined rate when detecting that the transmission rate exceeds a predetermined level. Typically then, synchronization signals are sent more often when the transmission rate exceeds certain levels because larger amounts of data are being sent to the mobile station 110. Conversely, synchronization signals may be sent less often when the transmission rate decreases because less data is being sent. In this way, the synchronization signals are sent more often when there is more data passing to the mobile station 110 thereby increasing efficiency or the accuracy of the synchronization signal. In other words, the synchronization signals are sent more often when the rate of data being sent to the mobile station 110 is higher. This is advantageous because if data is sent to the mobile station 110 more rapidly, a larger discrepancy can arise between the data sent from the primary base transceiver station 120 and the synchronization data at the neighboring base transceiver station(s) 130.

In yet another alternative, one or more predetermined mobile station handoff times are monitored such that the synchronization signal generator circuit 245 sends synchronization signals at a time that corresponds to the predetermined mobile station handoff time. In certain wireless communication systems 100, the mobile station 110 will handoff at certain predetermined times or intervals. Therefore, in this embodiment, the synchronization signal generator circuit 245 will send a synchronization signal a certain number of seconds prior to the predetermined mobile station handoff time to maximize the efficiency of the handoff. In other words, the synchronization signal will be sent such that it arrives at approximately, and typically exactly, the same time as the predetermined handoff time.

In a variation on the above alternative, the primary base transceiver station 120 sends a signal indicating that certain packets will not be transmitted until a predetermined packet sending time when the predetermined function of the at least one factor comprises sending the synchronization signal at predetermined times. In this alternative, the neighboring base transceiver station(s) 130 will have a record of which packets the primary base transceiver station 120 sent to the mobile station 110 at which time. Therefore, the neighboring base transceiver station(s) 130 will be able to quickly provide unsent packets to the mobile station 110 upon a handoff.

In several of the above embodiments, it will be understood that the rate at which synchronization signals are sent may vary along with the monitored factors instead of changing only upon a certain factor's reaching a predetermined amount. For example, in the embodiment where a monitor circuit monitors the signal strength between the mobile station 110 and the primary base transceiver station 120, the rate at which the synchronization signals are sent may vary in a reverse proportional manner with the signal strength between the mobile station 110 and primary base transceiver station 120. Such a continuously varying relationship between the synchronization signal rate and monitored factor may be employed for any monitored factor. Similarly, the synchronization signal rate may vary according to a combination of factors as may be determined by one skilled in the art.

By so tailoring the sending of synchronization signals, the wireless communication system effectively reduces the amount of redundant data sent to the mobile station during a handoff. Further, the wireless communication system experiences lessened traffic burdens by limiting unnecessary synchronization signals. Thus, overall efficiency in the wireless communication system is improved.

Further efficiencies may be gained through management of the base transceiver stations. For instance, the wireless communication system can determine a quality of channel factor for a base transceiver station of an active set of base transceiver stations and then determine, according to a predetermined function of the quality of channel factor, whether the base transceiver station should be assigned to a prefill set. The system may determine the quality of channel factor for assigning base transceiver stations to the prefill set in a number of ways including, for example, monitoring the signal quality between a mobile station and one or more base transceiver stations or by executing an anticipative signal strength algorithm.

By determining a prefill set of the active set, the wireless communication system can limit the amount of resources used to send synchronization signals to the base transceiver stations that are most likely to benefit from the signals. Further, the prefill and active sets may be utilized by the wireless communication system 100 to maximize efficiencies in communication between mobile stations such as by determining a target base transceiver station for a receiving mobile station at least in part by which base transceiver stations are in an active or prefill set for a sending mobile station.

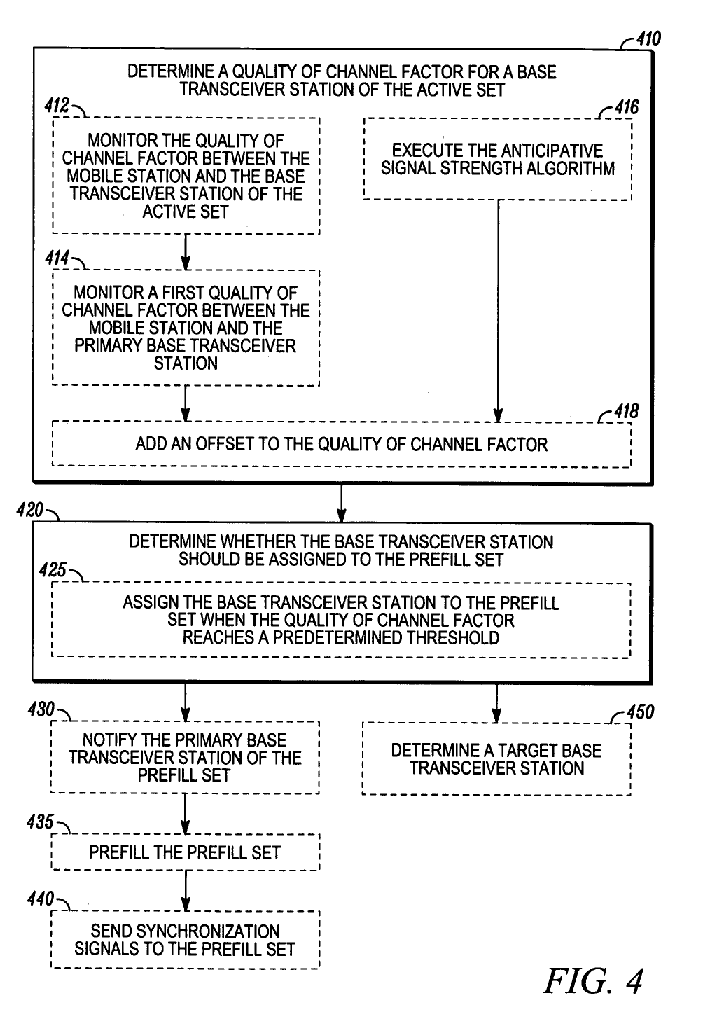

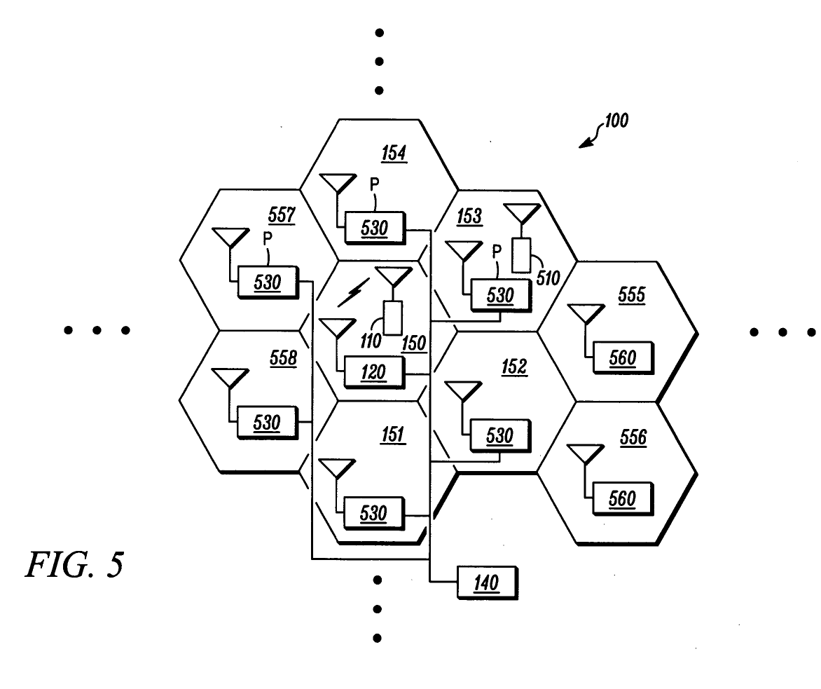

The operation of a typical embodiment for managing the base transceiver stations will be described with reference to FIG. 4. A quality of channel factor for a base transceiver station 130 of an active set is determined 410. Then, a processor circuit 217, 230, or 260 determines 420 whether the base transceiver station 130 should be assigned to a prefill set at least in part according to a predetermined function of the quality of channel factor. With momentary reference to FIG. 5, an active set of base transceiver stations will typically include those base transceiver stations 530 within communication range of the mobile station 110 such as those located in zones denoted by reference numerals 151, 152, 153, 154, 557, and 558 surrounding the zone 150 in which the mobile station 110 operates. Other, typically more distance, base transceiver stations 560 such as those in more distant zones 555 and 556 with typically poor communication with the mobile station 110 will be omitted from the active set. The base transceiver stations 530 and 560 are identical to or similar to the neighboring base transceiver stations 130 elsewhere in the wireless communication system 100. The prefill set, then, is typically a subset, designated for illustration purposes with the letter P in FIG. 5, of the active set of base transceiver stations 530 with improved communication with the mobile station 110 as compared with other base transceiver stations 530 of the active set. One skilled in the art will appreciate that the methods described herein are typically applied to each base transceiver station 530 of the active set to determine the prefill set. For simplicity, the embodiments of the invention will be described herein with reference to a single base transceiver station 530 of the active set.

Referring again to FIGS. 4 and 5, typically, determining 410 the quality of channel factor will include monitoring 412 the quality of channel factor between the mobile station 110 and the base transceiver station 530. Using this single monitored factor, the determination 420 of whether the base transceiver station 530 should be assigned to the prefill set may be made using a predetermined algorithm such as comparing the quality of channel factor against an absolute signal strength or other appropriate factor relating to the communication quality. The quality of channel factor may be monitored 412 by monitor circuit 215 or by a corresponding monitor in base transceiver station 530.

Alternatively, a monitor circuit 215 or 235 will monitor 414 a first quality of channel factor between the mobile station 110 and the primary base transceiver station 120. In this embodiment, the predetermined function of the quality of channel factor will include, at least in part, a function of the first quality of channel factor.

In one such embodiment, the predetermined function includes assigning 425 the base transceiver station 530 to the prefill set when the quality of channel factor for the base transceiver station 530 reaches a predetermined threshold, for example, relative to the first quality of channel factor. Generally, the predetermined threshold will define a quality of communication between the mobile station 110 and base transceiver station 530 such that the base transceiver station 530 is likely to be a target for the mobile station 110 upon the mobile station's next handoff. Typically, the predetermined threshold is when the quality of channel factor reaches about 80% of the first quality of channel factor when the quality of channel factor is a signal strength measurement. Alternatively, the predetermined threshold is when the quality is at least about three decibels below the first quality of channel factor when the quality of channel factor is a signal strength measurement.

Another alternative method of determining 410 the quality of channel factor includes executing an anticipative signal strength algorithm 416 to predict a signal strength between the mobile station 110 and the base transceiver station 530 such that the quality of channel factor is, at least in part, a function of the anticipative signal strength algorithm. The anticipative signal strength algorithm will typically be a known or readily developed algorithm based upon known or typical patterns of signal strength for the mobile station 110. For example, by analyzing a signal strength history stored in the mobile station 110 using known algorithms, the processor circuit 217 or 230 can predict the signal strength for the mobile station 110 given certain known conditions. In this manner, the quality of channel factor can be the output of the anticipative signal strength algorithm or include the output as part of other monitored conditions. One skilled in the art will recognize a variety of ways to determine the quality of channel factor using an anticipative signal strength algorithm in combination with certain monitored factors.

In an additional variation on the alternative ways to determine the quality of channel factor, an offset may be added 418 to the quality of channel factor wherein the offset is specific to each base transceiver station 530. In one such embodiment, the offset is determined at least in part according to a function of a relative load for a base transceiver station 530 of the active set. For example, the wireless communication system 100 may monitor the load for each base transceiver station 530 of the active set. As a way to help distribute the overall traffic load for the system, offsets may be assigned to each base transceiver station 530 such that the quality of channel factor disfavors assigning base transceiver stations 530 to the prefill set when the traffic load for the base transceiver station 530 exceeds a given amount. In this way, already loaded base transceiver stations 530 do not also receive synchronization signals because the base transceiver station 530 is not assigned to the prefill set.

Various alternatives are available for determining 420 whether the base transceiver station 530 should be assigned to the prefill set. For instance, this step may include executing the predetermined function at the mobile station 110 when the mobile station 110 monitors the first quality of channel factor with the primary base transceiver station 120 and the quality of channel factor with each base transceiver station 530 of the active set. In such an embodiment, the mobile station 110 sends a signal, typically through the primary base transceiver station 120, to the base station controller 140 that indicates an outcome of the predetermined function. In this embodiment, the base station controller 140 will control the assignment of base transceiver stations to the active set and prefill set for the mobile station 110 using the outcome, and various signals and other traffic in the wireless communication will be directed by the base station controller 140 accordingly.

Alternatively, the mobile station 110 and/or the various base transceiver stations may send the first quality of channel factor and quality of channel factor for the base transceiver stations of the active set to the base station controller 140. The base station controller 140, then, executes the predetermined function. In one such embodiment, the signal sent to the base station controller 140 includes at least a pilot strength measurement for each of the first quality of channel factor and quality of channel factor for the base transceiver station(s) 530 of the active set. Then, the base station controller 140 will control the assignment of base transceiver stations to the active set and prefill set for the mobile station 110 using the outcome of the predetermined function.

The wireless communication system 100 may use the prefill set in any number of ways. In one typical embodiment, the primary base transceiver station 120 will be notified 430 of the prefill set. Then, the base transceiver stations of the prefill set are prefilled 435, and the primary base transceiver station 120 sends 440 synchronization signals to each base transceiver station of the prefill set. Typically, the base transceiver stations of the prefill set will receive the same data to be sent to the mobile station 110 as that received by the primary base transceiver station 120. Thus, the sending of synchronization signals as described herein may be applied to the base transceiver stations of the prefill set thereby achieving further efficiencies by sending the synchronization signals only to those base transceiver stations identified in the prefill set.

In one further alternative embodiment, a target base transceiver station is determined 450 for the mobile station 110 at least in part according to the outcome of the predetermined function of the quality of channel factor. In this embodiment, a signal is sent to the mobile station 110 or other structure that determines the target base transceiver station during a handoff procedure indicating either an output of the predetermined function or an identity of the base transceiver stations 530 of the active set or prefill set. Typically, the mobile station 110 will be handed off to the base transceiver station with the best output of the predetermined function such that the target base transceiver station has the best quality of channel for the mobile station 110 or has the best combination of quality of channel and allocation of resources for the wireless communication system 100. Thus, the predetermined function of the quality of channel may further improve the quality of experience for the user and/or improve the efficiencies of the system during handoff operations.

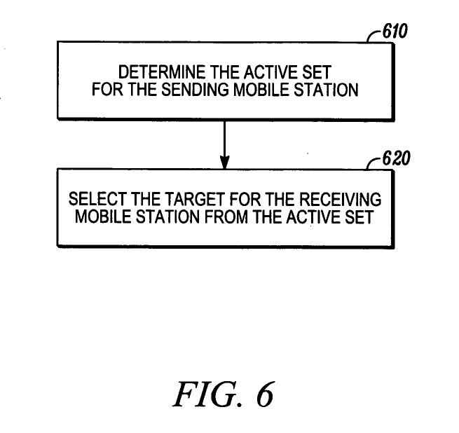

A further embodiment of the invention will be described in reference to FIGS. 5 and 6. The wireless communication system 100 determines 610 the active set of base transceiver stations 530 for a sending mobile station 110 as known in the art or using the various methods described herein regarding the determination of a prefill set. Then, a target base transceiver station for a receiving mobile station 510 is selected 620 from the active set of the sending mobile station 110. Typically, the step of selecting the target base transceiver station will include selecting the target base transceiver station with a maximum transmission capability from the sending mobile station 110 and an acceptable communication link with the receiving mobile station 510, usually a base transceiver station of the prefill set of the receiving mobile station 510. The maximum transmission capability is easily monitored; thus, the receiving mobile station 510 may experience the maximum quality of channel from the sending mobile station 110 such that the data stream from the sending mobile station 110 is not impeded during sending from the sending mobile station 110. In such a situation, the data may be relayed by the target base transceiver station without downloading the data back from the base station controller 140 and without sending the data to the base station controller 140. In this way, the wireless communication system 100 reduces system traffic by eliminating the need to send data down the communication chain when the data is already accessible within a given zone. In other words, this embodiment typically reduces any latency in the communication.

Thus, utilization of the various methods described herein in connection with the active and prefill sets of base transceiver stations can increase the efficiencies of a wireless communication system. Further, these methods will typically improve the quality of channel experienced by users of the system.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
determining a quality of channel factor for a base transceiver station of an active set;
determining whether the base transceiver station should be assigned to a prefill set at least in part according to a predetermined function of the quality of channel factor.

2. The method of claim 1 wherein the step of determining the quality of channel factor further comprises monitoring the quality of channel factor between a mobile station and the base transceiver station of the active set.

3. The method of claim 2 further comprising monitoring a first quality of channel factor between a mobile station and a primary base transceiver station; and wherein the predetermined function of the quality of channel factor further comprises at least in part a predetermined function of the first quality of channel factor.

4. The method of claim 3 wherein the predetermined function further comprises assigning the base transceiver station to the prefill set when the quality of channel factor for the base transceiver station reaches a predetermined threshold relative to the first quality of channel factor.

5. The method of claim 4 wherein the predetermined threshold is one of the group comprising:
when the quality of channel factor reaches about 80% of the first quality of channel factor when the quality of channel factor is a signal strength measurement;
when the quality of channel factor is at least about 3 decibels below the first quality of channel factor when the quality of channel factor is a signal strength measurement.

6. The method of claim 1 further comprising notifying a primary base transceiver station of the prefill set.

7. The method of claim 6 further comprising sending synchronization signals from the primary base transceiver station to each base transceiver station of the prefill set.

8. The method of claim 3 wherein the step of determining whether the base transceiver station should be assigned to the prefill set further comprises:
executing the predetermined function at a mobile station when the mobile station monitors the first quality of channel factor and the quality of channel factor; and
sending a signal to a base station controller which indicates an outcome of the predetermined function.

9. The method of claim 3 wherein the step of determining whether the base transceiver station should be assigned to the prefill set further comprises:
sending the first quality of channel factor and the quality of channel factor to a base station controller; and
executing the predetermined function at the base station controller.

10. The method of claim 9 wherein sending the first quality of channel factor and the quality of channel factor to the base station controller further comprises sending to the base station controller a signal comprising at least a pilot strength measurement for each of the first quality of channel factor and the quality of channel factor.

11. The method of claim 1 wherein the step of determining the quality of channel factor further comprises adding an offset to the quality of channel factor wherein the offset is specific to each base transceiver station.

12. The method of claim 11 wherein the offset is determined at least in part according to a function of a relative load for the base transceiver station.

13. The method of claim 1 wherein the step of determining the quality of channel factor further comprises executing an anticipative signal strength algorithm to predict a signal strength between a mobile station and the base transceiver station such that the quality of channel factor is at least in part a function of the anticipative signal strength algorithm.

14. The method of claim 1 wherein the predetermined function further comprises assigning the base transceiver station to the prefill set when the quality of channel factor reaches a predetermined threshold.

15. The method of claim 1 further comprising determining at a mobile station a target base transceiver station at least in part according to the outcome of the predetermined function.

16. A method of comprising:
determining an active set of base transceiver stations for a sending mobile station;
selecting a target base transceiver station for a receiving mobile station from the active set of the sending mobile station.

17. The method of claim 16 wherein the step of selecting a target base transceiver station further comprises selecting the target base transceiver station with a maximum transmission capability from the sending mobile station.

18. An apparatus comprising:
means for ascertaining a quality of channel factor for a mobile station and at least one base transceiver station; and
means for determining whether to assign to a prefill set the at least one base transceiver station at least in part according to a predetermined function of the quality of channel factor.

19. The apparatus of claim 18 wherein the means for ascertaining further comprises a monitor circuit incorporated into one of the group comprising the mobile station, and the at least one base transceiver station.

20. The apparatus of claim 18 wherein the means for ascertaining further comprises a processor circuit for applying an anticipative signal strength algorithm, and the processor circuit is incorporated into one of the group comprising the mobile station, the at least one base transceiver station, and a base station controller.
